(19) United States
(12) Patent Application Publication
(10) Pub. No.: US 2026/0285013 A1
(43) Pub. Date: Sep. 24, 2026

(54) ANTI-COLLISION GLAZING

(71) Applicant: SAINT-GOBAIN GLASS FRANCE, COURBEVOIE (FR)

(72) Inventors: Théo CHEVALLIER, FARIBAULT, MN (US); Anne PENILLARD, AUBERVILLIERS (FR)

(21) Appl. No.: 19/478,102

(22) PCT Filed: Apr. 22, 2024
(86) PCT No.: PCT/EP2024/060959

§ 371 Date: Oct. 23, 2025

(30) Foreign Application Priority Data
Apr. 25, 2023 (FR) FR2304128

(51) Int. Cl. B32B 17/10; B32B 17/06

(52) U.S. Cl. CPC B32B 17/10036; B32B 17/061; B32B 17/10201; B32B 17/10247; B32B 17/10513; B32B 2307/204; B32B 2419/06

(57) ABSTRACT

A multiple glazing suitable to be mounted in a building, on a facade and/or on a roof. An anti-collision glazing makes it possible to prevent, or at least reduce, the risk of birds colliding with the glazing.

The present invention relates to the field of multiple glazings suitable for being mounted in a building, on a facade and/or on a roof. More specifically, the invention relates to so-called “anti-collision” glazings which make it possible to avoid or at least limit the risks of a bird colliding with said glazing. The invention also relates to the manufacture of such a multiple glazing, as well as to its mounting in a building.

The present invention in particular relates to the integration of a diffuse reflection transparent layered element within such multi-glazing. The layered element may be rigid or flexible. In particular, it can be a glazing, for example, made of glass or polymer material. It also can be a flexible film based on a polymer material, especially able to be applied to a surface to provide it with diffuse reflection properties, while preserving its transmission properties.

Known glazings include standard transparent glazings, which result in specular transmission and reflection of incident radiation on the glazing, and translucent glazings, which result in diffuse transmission and reflection of incident radiation on the glazing.

Usually, the reflection by a glazing is said to be diffuse when incident radiation on the glazing at a given angle of incidence is reflected by the glazing in a plurality of directions. Reflection by a glazing is said to be specular when incident radiation on the glazing at a given angle of incidence is reflected by the glazing at an angle of reflection equal to the angle of incidence. Similarly, transmission through a glazing is called specular when incident radiation on the glazing at a given angle of incidence is transmitted by the glazing at an angle of transmission equal to the angle of incidence.

One disadvantage of standard transparent glazings is that they return sharp reflections, like mirrors, which is undesirable in certain applications. Thus, when a glazing is used for a building window, it is preferable for the presence of reflections, which reduce visibility through the glazing, to be limited. Sharp reflections on a glazing can also cause risks of glare, with ramifications in terms of safety, for example when vehicle headlights reflect on glazed building facades. This problem most particularly arises for glazed facades of airports. Indeed, it is essential to limit, as far as possible, the risk of glare for pilots approaching terminals.

Furthermore, translucent glazings, while offering the advantage of not generating sharp reflections, nevertheless do not make it possible to see clearly through the glazing.

In order to overcome these disadvantages, implementing a diffuse reflection transparent layered element is known from the prior art, including WO 2012/104547 A1, which layered element comprises two smooth outer main surfaces, as well as:
two outer layers, a lower outer layer and an upper outer layer, which each form one of the two main outer surfaces of the layered element and which consist of dielectric materials having substantially the same refractive index; and
a central layer interposed between the outer layers, this central layer being formed either by a single layer, which is a dielectric layer with a refractive index different to that of the outer layers or a metallic layer, or by a stack of layers, which comprises at least one dielectric layer with a refractive index different to that of the outer layers or a metallic layer,
where each contact surface between two adjacent layers of the layered element, one of which is dielectric and the other one of which is metallic, or which are two dielectric layers with different refractive indices, is textured and parallel to the other textured contact surfaces between two adjacent layers, one of which is dielectric and the other one of which is metallic, or which are two dielectric layers with different refractive indices.

The transparent substrate may consist, especially, of transparent polymer, transparent glass, transparent ceramic. When the transparent substrate is made of polymer, it may be rigid or flexible. In the form of a flexible film, such a transparent substrate is advantageously equipped, on one of its outer main surfaces, with an adhesive layer covered with a protective strip intended to be removed for the adhesive bonding of the film. The layered element in the form of a flexible film is then able to be added by adhesive bonding to an existing surface, for example, a surface of a glazing, in order to give this surface diffuse reflection properties, while maintaining specular transmission properties.

Each outer layer of the layered element can be formed by a stack of layers, provided that the various constituent layers of the outer layer are made of dielectric materials all having substantially the same refractive index.

Within the meaning of the invention, dielectric material or layer means a material or a layer with low electrical conductivity, below 100 S/m.

The term “index” refers to the optical refractive index, measured at the wavelength of 550 nm.

Within the meaning of the invention, two dielectric materials have substantially the same refractive index, or their refractive indices are substantially equal, when the absolute value of the difference between their refractive indices at 550 nm is less than or equal to 0.15. Preferably, the absolute value of the difference in refractive index at 550 nm between the constituent materials of the two outer layers of the layered element is lower than 0.05, and more preferably lower than 0.015.

Within the meaning of the invention, two dielectric layers have different refractive indices when the absolute value of the difference between their refractive indices at 550 nm is strictly greater than 0.15.

Throughout the description and with regard to the composition of the central layer, a distinction is made between metallic layers, on the one hand, for which the value of the refractive index is unimportant, and the dielectric layers, on the other hand, for which the difference in refractive index relative to that of the outer layers is to be taken into consideration.

Within the meaning of the invention, the contact surface between two adjacent layers is the interface between the two adjacent layers.

Within the scope of the invention, the following definitions are used:
A transparent element is an element through which there is specular transmission of radiation at least in the wavelength ranges useful for the intended application of the element. By way of an example, when the element is used as a building or vehicle glazing, it is transparent at least in the visible wavelength range.
A smooth surface is a surface for which the dimensions of surface irregularities are less than the wavelength of the incident radiation on the surface, so that the radiation is not deflected by these surface irregularities. The incident radiation is then transmitted and reflected in specular fashion by the surface.
A textured surface is a surface for which the surface irregularities vary at a scale greater than the wavelength of the incident radiation on the surface. The incident radiation is then transmitted and reflected diffusely by the surface.

The parallelism of the textured contact surfaces implies that the one or each constituent layer of the central layer, which is dielectric with a different refractive index to that of the outer layers, or which is metallic, has a uniform thickness perpendicular to the contact surfaces of the central layer with the outer layers. This uniformity in the thickness can be global, over the entire extent of the texture, or local, in segments of the texture. In particular, when the texture has variations in slope, the thickness between two consecutive textured contact surfaces may change, from segment to segment, depending on the slope of the texture, yet with the textured contact surfaces always remaining parallel to one another. This is especially the case for a layer deposited by sputtering, where the thickness of the layer is thinner when the slope of the texture increases. Thus, locally, in each segment of texture with a given slope, the thickness of the layer remains constant, but the thickness of the layer differs between a first segment of texture with a first slope and a second segment of texture with a second slope different to the first slope.

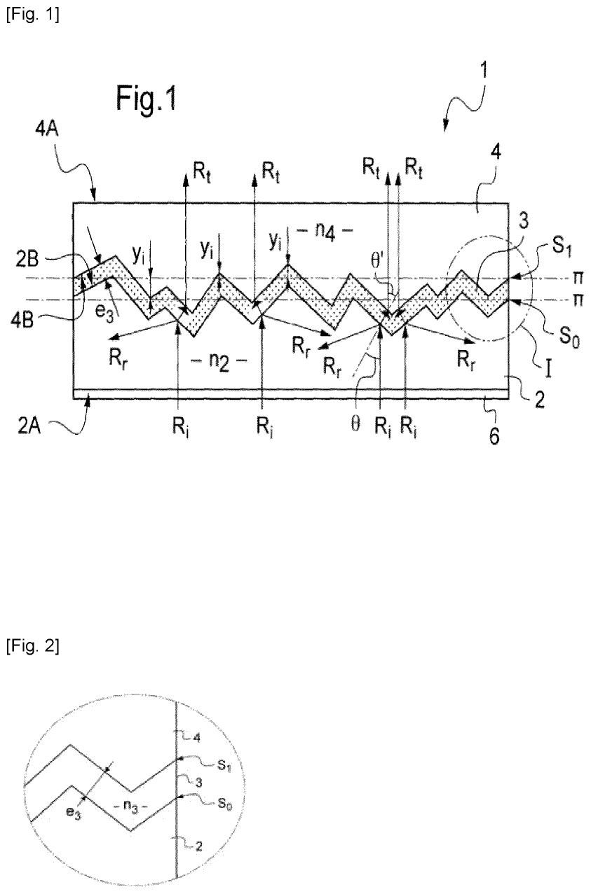

FIGS. 1 to 3 show such a transparent layered element known in the state of the art. For the sake of the clarity of the drawing, the relative thicknesses of the various layers have not been rigorously respected. Furthermore, the possible variation in thickness of each constituent layer of the central layer as a function of the slope of the texture has not been shown in the figures, with it being understood that this possible thickness variation has no impact on the parallelism of the textured contact surfaces. Specifically, for each given slope of the texture, the textured contact surfaces are parallel to one another.

Throughout the description, the transparent layered element is considered to be laid horizontally, with its first face oriented downwards defining a lower outer main surface, and its second face, opposite the first face, oriented upwards defining an upper outer main surface; the meanings of the expressions “above” and “below” are thus to be considered in relation to this orientation. Unless specifically stated, the expressions “above” and “below/under” do not necessarily mean that the two layers are disposed in contact with one another. The terms “lower” and “upper” are used herein with reference to this positioning.

It should be noted that the expression “ranging between . . . and . . . ” includes the limits in the range.

The layered element 1 shown in FIG. 1 comprises two outer layers 2 and 4 that are made of transparent dielectric materials having substantially the same refractive index n2, n4. Each outer layer 2 or 4 has a smooth main surface, 2A or 4A, respectively, that is directed towards the outside of the layered element, and a textured main surface, 2B or 4B, respectively, that is directed towards the inside of the layered element.

The smooth outer surfaces 2A and 4A of the layered element 1 allow specular transmission of radiation to each surface 2A and 4A, that is, allow radiation to enter an outer layer or radiation to exit an outer layer without changing the direction of the radiation.

The textures of the internal surfaces 2B and 4B match each other. As is clearly visible in FIG. 1, the textured surfaces 2B and 4B are positioned opposite one another, in a configuration where their textures are strictly parallel to one another. The layered element 1 also comprises a central layer 3, interposed in contact between the textured surfaces 2B and 4B.

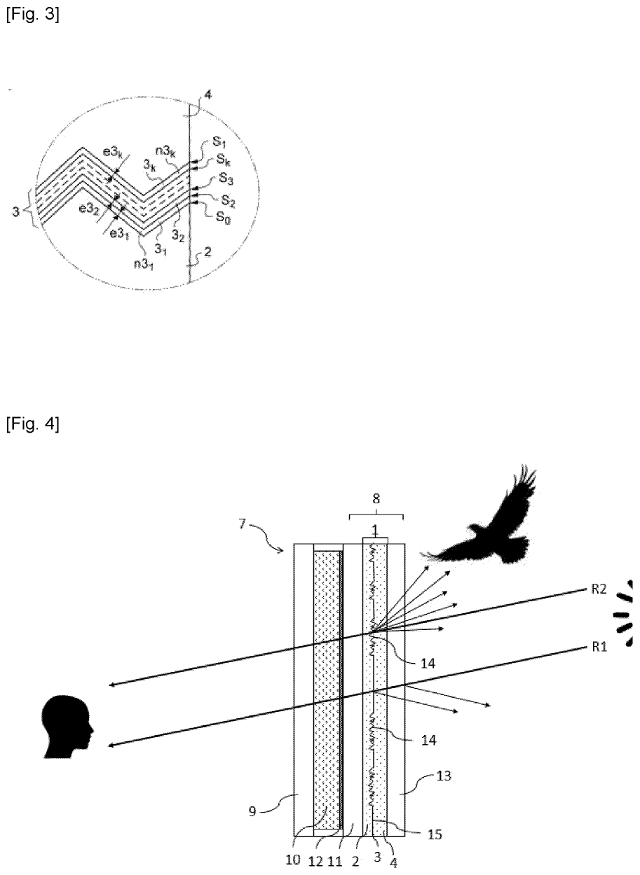

In the variant shown in FIG. 2, the central layer 3 is a single layer and is made up of a transparent material, which is either metallic, or dielectric with a refractive index n3 different to that of the outer layers 2 and 4. In the variant shown in FIG. 3, the central layer 3 is formed by a transparent stack of several layers 31, 32, . . . , 3k, where at least one of the layers 31 to 3k is either a metallic layer, or a dielectric layer with a refractive index different to that of the outer layers 2 and 4. Preferably, at least each of the two layers 31 and 3k located at the ends of the stack is a metallic layer or a dielectric layer with a refractive index n31 or n3k different to that of the outer layers 2 and 4.

In FIGS. 1 to 3, S0 denotes the contact surface between the outer layer 2 and the central layer 3, and S1 denotes the contact surface between the central layer 3 and the outer layer 4. Furthermore, in FIG. 3, the inner contact surfaces of the central layer 3 are successively denoted S2 to Sk, starting from the contact surface closest to the surface S0.

In the variant of FIG. 2, due to the arrangement of the central layer 3 in contact between the textured surfaces 2B and 4B that are parallel to one another, the contact surface S0 between the outer layer 2 and the central layer 3 is textured and parallel to the contact surface S1 between the central layer 3 and the outer layer 4. In other words, the central layer 3 is a textured layer having, at least locally, a uniform thickness e3, taken perpendicular to the contact surfaces S0 and S1.

In the variant of FIG. 3, each contact surface S2, . . . , Sk between two adjacent layers of the constituent stack of the central layer 3 is textured and strictly parallel to the contact surfaces S0 and S1 between the outer layers 2, 4 and the central layer 3. Thus, all the contact surfaces S0, S1, . . . , Sk between adjacent layers of the element 1 that are either of different natures, dielectric or metallic, or are dielectric with different refractive indices, are textured and parallel to one another. In particular, each layer 31, 32, . . . 3k of the stack forming the central layer 3 has, at least locally, a uniform thickness e31, e32, . . . , e3k, taken perpendicular to the contact surfaces S0, S1, . . . , Sk.

As shown in FIG. 1, the texture of each contact surface S0, S1 or S0, S1, . . . , Sk of the layered element 1 is formed by a plurality of textures that are recessed or protruding relative to a general plane TT of the contact surface.

FIG. 1 shows the path of radiation, which is incident on the layered element 1 on the side of the outer layer 2. Incident rays Ri arrive perpendicular to the outer layer 2. As shown in FIG. 1, when incident rays Ri reach the contact surface S0 between the outer layer 2 and the central layer 3, with a given angle of incidence θ, these rays are reflected either by the metallic surface, or due to the difference in refractive index on this contact surface, respectively between the outer layer 2 and the central layer 3 in the variant of FIG. 2 and between the outer layer 2 and the layer 31 in the variant of FIG. 3. As the contact surface S0 is textured, the reflection takes place in a plurality of directions Rr. The reflection of the radiation by the layered element 1 is therefore diffuse.

A portion of the incident radiation is also refracted in the central layer 3. In the variant of FIG. 2, the contact surfaces S0 and S1 are parallel to one another, which implies, according to the Snell-Descartes law, that n2.sin (θ)=n4.sin (θ′), where θ is the angle of incidence of the radiation on the central layer 3 starting from the first outer layer 2 and 0′ is the angle of refraction of the radiation in the second outer layer 4 starting from the central layer 3. In the variant of FIG. 3, since the contact surfaces S0, S1, . . . , Sk are all parallel to one another, the relationship n2.sin(θ)=n4.sin (θ′) derived from the Snell-Descartes law remains proven. Hence, in the two variants, since the refractive indices n2 and n4 of the two outer layers are substantially equal to one another, the rays Rt transmitted by the layered element are transmitted with an angle of transmission θ′ equal to their angle of incidence θ on the layered element. The transmission of the radiation by the layered element 1 is therefore specular.

Similarly, in both variants, incident radiation on the layered element 1 on the side of the outer layer 4 is diffusely reflected and specularly transmitted by the layered element, for the same reasons as above.

Examples of polymers which are appropriate for the transparent substrate comprise, especially, polyesters such as polyethylene terephthalate (PET), polybutylene terephthalate (PBT), polyethylene naphthalate (PEN); polyacrylates such as polymethyl methacrylate (PMMA); polycarbonate; polyurethane; polyamides; polyimides; fluorinated polymers such as ethylene tetrafluoroethylene (ETFE), polyvinylidene fluoride (PVDF), polychlorotrifluoroethylene (PCTFE), ethylene chlorotrifluoroethylene (ECTFE), fluorinated ethylene-propylene copolymers (FEP); photocrosslinkable and/or photopolymerizable resins, such as thiolene, polyurethane, urethane-acrylate, polyester-acrylate.

Examples of glass substrates that can be used directly as an outer layer of the layered element include:
the glass substrates sold by the company Saint-Gobain Glass in the SATINOVO® range, which are already textured and have, on one of their main surfaces, a texture obtained by sandblasting or acid treatment;
the glass substrates sold by the company Saint-Gobain Glass in the ALBARINOR S, P or G range or in the MASTERGLASS® range, which have, on one of their main surfaces, a texture obtained by rolling,
the high-index glass substrates textured by sandblasting, such as flint glass, for example, sold by Schott under the references SF6 (n=1.81), 7SF57 (n=1.85), N-SF66 (n=1.92), P-SF68 (n=2.00).

Examples of central layers that can be inserted between outer layers include thin dielectric layers, selected from oxides, nitrides or halides of one or several transition metals, non-metals or alkaline earth metals, especially layers of Si3N4, SnO2, ZnO, ZrO2, SnZnOx, AlN, NbO, NbN, TiO2, SiO2, Al2O3, MgF2, AlF3, or thin metallic layers, in particular layers of silver, gold, copper, titanium, niobium, silicon, aluminum, nickel-chromium (NiCr) alloy, stainless steel, or alloys of these metals.

The texturing of one of the main surfaces of the outer layers may be obtained by any known texturing method, for example, by embossing the surface of the substrate heated beforehand to a temperature at which it can be deformed, in particular by rolling using a roller whose surface has texturing matching the texturing to be formed on the substrate; by abrasion by means of particles or abrasive surfaces, in particular by sandblasting; by chemical treatment, especially treatment with acid in the case of a glass substrate; by molding, especially injection molding in the case of a substrate of thermoplastic polymer; or by etching.

The texturing of each contact surface between two adjacent layers of the layered element, one of which is dielectric and the other one of which is metallic, or which are two dielectric layers with different refractive indices, is random over the contact surface. As a variant, the texturing of each contact surface between two adjacent layers of the layered element, one of which is dielectric and the other one of which is metallic, or which are two dielectric layers with different refractive indices, is periodic over the contact surface. Such texturing can especially be in the form of cones, pyramids, grooves, ribs or ripples.

In a known manner, a layered element as described hereinbefore can be obtained via a manufacturing method comprising the following steps of:
a) providing (S1), as a lower outer layer 2, a transparent substrate, one of the main surfaces 2B of which is textured and the other main surface 2A of which is smooth;
b) depositing S2 a central layer 3 onto the textured main surface 2B of the lower outer layer 2, either when the central layer 3 is formed by a single layer, which is a dielectric layer with a refractive index different to that of the outer layer 2 or a metallic layer, by depositing the central layer 3 in a conformal manner onto said textured main surface 2B, or, when the central layer 3 is formed by a stack of layers (31, 32, . . . , 3k) comprising at least one dielectric layer with a refractive index different to that of the first outer layer 2 or a metallic layer, by successively depositing the layers (31, 32, . . . , 3k) of the central layer 3 in a conformal manner onto said textured main surface 2B;
c) forming (S3) the upper outer layer 4 on the textured main surface 3B of the central layer 3 opposite the lower outer layer 2, where the lower 2 and upper 4 outer layers are made of dielectric materials with substantially the same refractive index.

The conformal deposition of the central layer 3, whether it is a single layer or formed by a stack of several layers, preferably must be carried out in a vacuum, by magnetron cathode sputtering. In particular, this technique allows either the single layer to be deposited onto the textured surface 2B of the substrate 2 in a conformal manner, or the various layers of the stack to be deposited successively in a conformal manner to the texture. In other words, the implementation of this technique ensures that the surfaces delimiting the various layers are parallel to each other.

Alternatively or in combination, the central layer 3 can be deposited by screen printing and comprises:
b1) positioning a screen printing screen opposite the textured main surface of the lower outer layer,
b2) depositing a dielectric layer with a refractive index different to that of the outer layers, or a metallic layer, on the screen printing screen, preferably using a doctor blade.

A requirement exists for making building glazings clearly visible to birds so that they do not accidentally hit them. One known solution for addressing this problem is to texture the exterior face of the glazing in order to reveal a pattern that is visible to birds.

One identified disadvantage is that the pattern is blurred for an observer located inside the building, due to the diffuse transmission of light at this point. At least from an aesthetic point of view, this is not desirable.

A requirement therefore exists to provide anti-collision multiple glazing provided with an anti-collision pattern which, on the one hand, offers satisfactory visibility for a bird and, on the other hand, limits or eliminates the blur that may be perceived by an observer located inside the building.

The present invention addresses this need. More particularly, in at least one embodiment, the proposed technique relates to a multi-glazing adapted to be mounted in a building, on a facade and/or the roof, comprising at least an exterior laminated glazing and an interior glazing separated by a gas gap and respectively intended to be arranged towards the outside and the inside of the building, said laminated glazing integrating a transparent layered element comprising two smooth outer main surfaces, as well as:
two outer layers, a lower outer layer and an upper outer layer, at least one of which is a laminating interlayer, and which each form one of the two main outer surfaces of the layered element and which are made of dielectric materials having substantially the same refractive index; and
a central layer interposed between the outer layers, this central layer being formed either by a single layer, which is a dielectric layer with a refractive index different to that of the outer layers or a metallic layer, or by a stack of layers, which comprises at least one dielectric layer with a refractive index different to that of the outer layers or a metallic layer,
or a first portion of each contact surface between two adjacent layers of the layered element, one of which is dielectric and the other one of which is metallic, or which are two dielectric layers with different refractive indices, is textured and parallel to the other textured contact surfaces between two adjacent layers,
and where a second portion of each contact surface between two adjacent layers of the layered element is smooth,
characterized in that said first portion forms a textured pattern that contrasts with a background formed by the second portion,
said pattern being such that:
   each subset of said pattern is separated from an adjacent subset by a distance of less than 10.16 cm, preferentially less than 5.08 cm,
   said pattern has relative to the background a visibility “SCORE” greater than or equal to 0, and which satisfies the equation:

$$SCORE = 0.85 * AS + 0.15 * Δ L$$

Where ΔS is the chromatic contrast and satisfies the equation:

$$\text{?}$$

$$\text{?} \text{indicates text missing or illegible when filed}$$

Where “wi” is the Weber fraction representing the sensitivity of a cone “i” of the retina of a bird,

Where “Δfi” is the real perception difference between said pattern (14) and the background (15), Where “fi” satisfies the equation:

$$fi = ln ( Qi / Qi\_ref )$$

where Qi is the sensory response of a cone “i” of the retina of a bird and satisfies the equation:

$${Q}_{i} = {\int }_{λ} {R}_{i} ( λ ) S ( λ ) I ( λ ) d λ$$

Where “λ” is the wavelength, “S” is the considered spectrum, “I” is the illuminant D65 according to standard EN410 which describes the average solar spectrum and “Ri” is the sensitivity spectrum of said cone “i”, Where “Qi_ref” corresponds to “Qi” with S equal to 1, Where “ΔL” is the achromatic contrast and satisfies the equation:

$$Δ L = Δ f\_achromatic / w\_achromatic$$

Where “w_achromatic” is equal to 0.1 is the Weber fraction representing the achromatic sensitivity of the retina of a bird,

Where “Δf_achromatic” is the difference in real achromatic perception between said pattern (X) and the background (X),

Where “f_achromatic” satisfies the equation:

$$f\_achromatic = ln ( Q / Q\_ref )$$

Where Q is the achromatic sensory response of the retina of a bird and satisfies the equation:

$$Q = {\int }_{λ} R ( λ ) S ( λ ) I ( λ ) d λ$$

Where “R” is the achromatic sensitivity spectrum,

Where “Q_ref” corresponds to “Q” with S equal to 1.

Within the meaning of the invention, a multi-glazing means a plurality of glazings, which may or may not be laminated, spaced apart and separated by one or two gas or vacuum gaps, depending on whether the multi-glazing is a double or triple glazing. Clearly, the use of an anti-collision multi-glazing is particularly useful in the building sector.

According to the invention, the textured and reflective pattern formed within the layered element contrasts with the background in the sense that it is visually distinct therefrom, at least from the viewpoint of a bird. This background therefore corresponds to a surface defined in opposition to the textured reflective pattern, such as a negative thereof.

The present invention resides firstly in selecting an anti-collision pattern based on a geometric criterion, but also on a contrast criterion: the visibility score. This “SCORE” has excellent reliability, since it takes into account the optical perception of a bird in all its complexity, and in particular with regard to both the chromatic and achromatic sensitivity of its retina. A multi-glazing having a score greater than or equal to 0 thus makes it possible to satisfactorily limit the risk of a bird collision with a glazing.

As detailed in the description, the implementation of a central reflective layer enables diffuse reflection at the textured pattern, thus making it visible from the viewpoint of a bird.

Finally, the integration of such an anti-collision pattern within a transparent element with diffuse reflection eliminates, or at least limits, the blur that may be perceived by an observer located inside the building, at the pattern.

According to a particular embodiment, said laminated glazing integrates an electrochromic stack.

Within the meaning of the invention, an electrochromic stack, also called an electrochemical functional system with electrically controllable optical and/or energy properties, comprises at least one electrochemically active layer arranged between a first electrode coating and a second electrode coating, the at least one electrochemically active layer being adapted to switch, under the effect of an appropriate electrical power supply and reversibly, between a clear state and a tinted state, the optical and/or energy properties of which vary. Such properties particularly relate to transmission, absorption, reflection, or light scattering. The induced variation generally occurs in the optical field (infrared, visible, ultraviolet) and/or in other fields of electromagnetic radiation, hence why it is called a device with variable optical and/or energy properties, as the optical domain is not necessarily the only domain concerned.

As detailed in the description, the combination, within the multi-glazing, of an anti-collision pattern and of an electrochromic stack has the advantage of increasing the contrast between the pattern and the background, as perceived by a bird. In other words, the anti-collision pattern appears more visible to a bird.

According to a particular embodiment, said electrochromic stack is in contact with said gas gap.

According to a particular embodiment, said electrochromic stack forms at least part of said central layer.

According to a particular embodiment, one of said outer layers of the layered element is formed by an external substrate of said laminated glazing intended to be arranged towards the outside of the building.

According to a particular embodiment, one of said outer layers of the layered element is formed by an interior substrate of said laminated glazing intended to be arranged towards the inside of the building.

According to a particular embodiment, the Weber fraction “wi” representing the sensitivity of a cone “i” of the retina of a bird is selected according to the following specific values: W1=0.2; W2=0.14142; W3=0.14142; W4=0.1.

Such a set of Weber fractions corresponds to the typical sensitivity of a bird. The selection of such a set of Weber fractions therefore makes it possible to provide an anti-collision pattern whose visibility is excellent for the large majority of avian species.

According to a particular embodiment, said pattern comprises wavy or rectilinear strips.

According to a particular embodiment, said pattern comprises dots.

According to a particular embodiment, the invention also relates to a method comprising a step of manufacturing such a multi-glazing.

According to a particular embodiment, the invention also relates to a method comprising a step of mounting at least one such multi-glazing in a building, on a facade and/or on the roof.

Further features and advantages of the invention will become apparent from the following description of particular embodiments, given merely as illustrative and non-limiting examples, and the appended figures, for which:

FIG. 1 is a schematic cross section of a layered element known from the state of the art;

FIG. 2 is a larger scale view of the detail I of FIG. 1 for a first variant of the layered element known from the state of the art;

FIG. 3 is a larger scale view of the detail I of FIG. 1 for a second variant of the layered element known from the state of the art; and

FIG. 4 is a schematic cross-sectional view of a multiple glazing according to a first particular embodiment of the invention,

FIG. 5 is a schematic cross-sectional view of a multiple glazing according to a second particular embodiment of the invention,

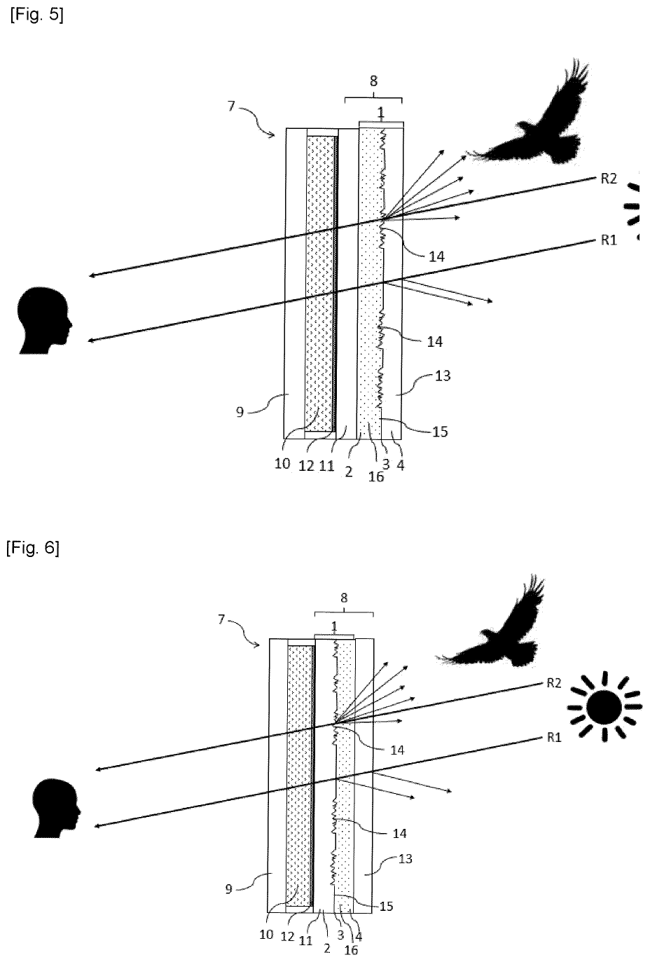

FIG. 6 is a schematic cross-sectional view of a multiple glazing according to a third particular embodiment of the invention.

The different features illustrated by the figures are not depicted at full scale, as the focus is on the depiction of the general operation of the invention.

In particular, the exact path of the incident solar rays within the multiple glazing is not shown, especially the angular deviations that can be generated at each interface, as the diagram focuses more on the illustration of the diffuse reflection generated on the pattern 14, as opposed to the specular reflection generated on the background 15.

According to a first particular embodiment and as shown in FIG. 4, the invention relates to a multiple glazing 7 adapted to be mounted in a building, on a facade and/or on the roof, comprising at least one exterior laminated glazing 8 and an interior glazing 9 separated by a gas gap 10 and respectively intended to be arranged towards the outside and the inside of the building. In FIG. 1, a sun and a bird are positioned outside the building, while an observer is positioned inside. The exterior laminated glazing 8 integrates a transparent layered element 1, which forms a laminated interlayer 16 and is interposed between an interior transparent substrate 11 coated with an electrochromic stack 12 in contact with said gas gap 10, and an exterior transparent substrate 14.

The transparent layered element 1 comprises a reflective central layer 3 between a lower outer layer 2 and an upper outer layer 4.

According to the invention, a first portion 14 of the interface between the lower outer layer 2 and the upper outer layer 4 is textured and forms, with the assistance of the reflective central layer 3, a textured pattern 14 that contrasts with a background 15 formed by a smooth portion of this same interface.

In order to highlight the scattering effect generated on the textured pattern 14, two incident solar light rays R1 and R² are shown in FIG. 4. The first ray R1 passes the layered element 1 on the background 15. Since the central layer 3 is smooth at this location, as opposed to the textured interface of the pattern 14, the ray R1 is transmitted and reflected in a specular manner. Therefore, a bird does not see this background zone 15. In contrast, the second ray R2 passes through the layered element 1 at the reflective textured pattern 14. The second ray R2 is then transmitted in a specular manner, due to the structure of the layered element, and is reflected in a diffuse manner, that is, in a plurality of directions. The risk of generating transmission blurring is therefore limited, if not eliminated. A portion of the rays reflected in a diffuse manner then can be perceived by a bird, which then distinguishes a pattern 14, contrasting with the background 15.

It should be noted that, according to the invention, the laminated glazing “integrates” a layered element 1 in the sense that this layered element 1 can be interposed between the interior 11 and exterior 13 transparent substrates of the glazing, as illustrated in FIG. 4, or, alternatively, that one of these two substrates (11, 13) forms one of the outer layers (2, 4) of the layered element 1, as illustrated in FIGS. 5 and 6.

Thus, and in a second particular embodiment illustrated in FIG. 5, the exterior transparent substrate 13 acts as the upper outer layer 4 and comprises the textured pattern 14 on a portion of its interior face.

According to a third particular embodiment illustrated in FIG. 6, it is the interior transparent substrate 11 that acts as the lower outer layer 2 and comprises the textured pattern 14 on a portion of its exterior face, that is, intended to be oriented towards the outside of the building.

According to an alternative embodiment covered by the invention, the central layer 3 consists of said electrochromic stack 12.

In order to better understand what is perceived by the bird, the composition of the light spectrum perceived, on the one hand, at the pattern 14, and, on the other hand, at the background 15, needs to be described. In general, the spectrum observed by the bird can be considered to be the sum of the diffuse light exiting the building and the reflected solar light scattered by the multi-glazing.

At the background 15, which is a smooth interface, the reflection is specular and therefore can be ignored. As for the diffuse light exiting the building, it can be estimated that it corresponds to the sunlight transmitted into the building, reflected in a diffuse manner on the interior walls and retransmitted outward.

The “BKG” spectrum of the background 15 as seen by a bird is therefore as follows:

$$BKG = \% T\_window \hat{} 2 * \% R\_wall$$

Where % T_window is the overall transmission of the glazing,
Where % R_wall can be considered to be a fixed value of 40%, in the event that the interior walls of the building return 40% of the solar radiation (albedo).

At the pattern 14, which is a textured and reflective interface, the reflection is diffuse and therefore must be added. As for the diffuse light exiting the building, it is transmitted in a diffuse manner by the pattern 14.

The “PTRN” spectrum of the pattern 14 as seen by a bird is therefore as follows:

$$PTRN = \% T\_window * \% R\_wall + \% R\_pattern$$

Where % R_pattern is its diffuse reflection on said pattern 14.

According to the invention, the textured and reflective pattern 14 is characterized in that:
each subset of said pattern 14 is separated from an adjacent subset by a distance of less than 10.16 cm, preferentially less than 5.08 cm, and
said pattern 14, has relative to the background 15, a visibility “SCORE” that is greater than or equal to 0, and which satisfies the equation:

$$SCORE = 0.85 * Δ S + 0.15 * Δ L$$

According to this particular embodiment, the Weber fraction “wi” representing the sensitivity of a cone “i” of the retina of a bird is selected according to the following specific values: W1=0.2; W2=0.14142; W3=0.14142; W4=0.1.

As indicated above, the value of this SCORE directly depends on the sensory response (Q; Qi) of the retina of the bird, of which one of the components “S” is the value of the spectrum observed.

This provides a better understanding of the advantage provided by the implementation of an electrochromic stack 12, in combination with the anti-collision pattern 14. This electrochromic stack, by being tinted, will generate a significant drop in the light transmission through the multi-glazing (% T_window). With reference to the definitions provided above for the spectra of the pattern 14 (“PTRN”) and of the background 15 (“BKG”), it will be understood that when the light transmission drops, the first part of the computation of the spectrum (% T_window\hat{ }2*% R_wall) tends towards 0. The “BKG” spectrum of the background 15 then tends to 0, whereas the “PTRN” spectrum of the pattern 14 tends towards the diffuse reflection value “% R_pattern” of the pattern 14, hence an increase in the contrast perceived by a bird between the pattern 14 and the background 15. When the electrochromic stack switches to its tinted state, the anti-collision pattern 14 is thus more visible to a bird.

The visual functions Ri and R used for the present invention are detailed in Table 1 [Tables 1] below, as a function of the wavelength A:

TABLE 1

| | Visual | | | | Achromatic |
|---|---|---|---|---|---|
| λ | R1 | R2 | R3 | R4 | Rachro |
| 300 | 0.00E+00 | 0 | 0 | 0 | 1.99E−06 |
| 301 | 0.00E+00 | 0 | 0 | 0 | 2.36E−06 |
| 302 | 0.00E+00 | 0 | 0 | 0 | 2.95E−06 |
| 303 | 0.00E+00 | 0 | 0 | 0 | 3.85E−06 |
| 304 | 0.00E+00 | 0 | 0 | 0 | 5.25E−06 |
| 305 | 0.00E+00 | 0 | 0 | 0 | 7.38E−06 |
| 306 | 0.00E+00 | 0 | 0 | 0 | 1.06E−05 |
| 307 | 0.00E+00 | 0 | 0 | 0 | 1.54E−05 |
| 308 | 0.00E+00 | 0 | 0 | 0 | 2.27E−05 |
| 309 | 0.00E+00 | 0 | 0 | 0 | 3.30E−05 |
| 310 | 0.00E+00 | 0 | 0 | 0 | 4.67E−05 |
| 311 | 0.00E+00 | 0 | 0 | 0 | 6.38E−05 |
| 312 | 0.00E+00 | 0 | 0 | 0 | 8.30E−05 |
| 313 | 0.00E+00 | 0 | 0 | 0 | 1.03E−04 |
| 314 | 0.00E+00 | 0 | 0 | 0 | 1.23E−04 |
| 315 | 0.00E+00 | 0 | 0 | 0 | 1.42E−04 |
| 316 | 2.33E−05 | 0 | 0 | 0 | 1.59E−04 |
| 317 | 1.49E−04 | 0 | 0 | 0 | 1.75E−04 |
| 318 | 2.72E−04 | 0 | 0 | 0 | 1.88E−04 |
| 319 | 3.92E−04 | 0 | 0 | 0 | 2.00E−04 |
| 320 | 5.11E−04 | 0 | 0 | 0 | 2.10E−04 |
| 321 | 6.27E−04 | 0 | 0 | 0 | 2.19E−04 |
| 322 | 7.41E−04 | 0 | 0 | 0 | 2.27E−04 |
| 323 | 8.53E−04 | 0 | 0 | 0 | 2.35E−04 |
| 324 | 9.62E−04 | 0 | 0 | 0 | 2.42E−04 |
| 325 | 1.07E−03 | 0 | 0 | 0 | 2.49E−04 |
| 326 | 1.17E−03 | 0 | 0 | 0 | 2.56E−04 |
| 327 | 1.28E−03 | 0 | 0 | 0 | 2.62E−04 |
| 328 | 1.38E−03 | 0 | 0 | 0 | 2.68E−04 |
| 329 | 1.48E−03 | 0 | 0 | 0 | 2.74E−04 |
| 330 | 1.57E−03 | 0 | 0 | 0 | 2.80E−04 |
| 331 | 1.67E−03 | 0 | 0 | 0 | 2.86E−04 |
| 332 | 1.76E−03 | 0 | 0 | 0 | 2.92E−04 |
| 333 | 1.85E−03 | 0 | 0 | 0 | 2.97E−04 |
| 334 | 1.95E−03 | 0 | 0 | 0 | 3.03E−04 |
| 335 | 2.04E−03 | 0 | 0 | 0 | 3.08E−04 |
| 336 | 2.12E−03 | 0 | 0 | 0 | 3.13E−04 |
| 337 | 2.21E−03 | 0 | 0 | 0 | 3.18E−04 |
| 338 | 2.30E−03 | 0 | 0 | 0 | 3.23E−04 |
| 339 | 2.39E−03 | 0 | 0 | 0 | 3.28E−04 |
| 340 | 2.48E−03 | 0 | 0 | 0 | 3.33E−04 |
| 341 | 2.56E−03 | 0 | 0 | 0 | 3.38E−04 |
| 342 | 2.65E−03 | 0 | 0 | 0 | 3.43E−04 |
| 343 | 2.74E−03 | 0 | 0 | 0 | 3.48E−04 |
| 344 | 2.83E−03 | 0 | 0 | 0 | 3.53E−04 |
| 345 | 2.92E−03 | 0 | 0 | 0 | 3.59E−04 |
| 346 | 3.01E−03 | 0 | 0 | 0 | 3.64E−04 |
| 347 | 3.11E−03 | 0 | 0 | 0 | 3.69E−04 |
| 348 | 3.20E−03 | 0 | 0 | 0 | 3.74E−04 |
| 349 | 3.30E−03 | 0 | 0 | 0 | 3.78E−04 |
| 350 | 3.40E−03 | 0 | 0 | 0 | 3.83E−04 |
| 351 | 3.50E−03 | 0 | 0 | 0 | 3.87E−04 |
| 352 | 3.61E−03 | 0 | 0 | 0 | 3.92E−04 |
| 353 | 3.71E−03 | 0 | 0 | 0 | 3.95E−04 |
| 354 | 3.82E−03 | 0 | 0 | 0 | 3.99E−04 |
| 355 | 3.93E−03 | 0 | 0 | 0 | 4.03E−04 |
| 356 | 4.05E−03 | 0 | 0 | 0 | 4.05E−04 |
| 357 | 4.17E−03 | 0 | 0 | 0 | 4.07E−04 |
| 358 | 4.29E−03 | 0 | 0 | 0 | 4.10E−04 |
| 359 | 4.41E−03 | 0 | 0 | 0 | 4.12E−04 |
| 360 | 4.54E−03 | 0 | 0 | 0 | 4.14E−04 |
| 361 | 4.67E−03 | 0 | 0 | 0 | 4.15E−04 |
| 362 | 4.80E−03 | 0 | 0 | 0 | 4.16E−04 |
| 363 | 4.94E−03 | 0 | 0 | 0 | 4.17E−04 |
| 364 | 5.07E−03 | 0 | 0 | 0 | 4.18E−04 |
| 365 | 5.22E−03 | 0 | 0 | 0 | 4.19E−04 |
| 366 | 5.36E−03 | 0 | 0 | 0 | 4.20E−04 |
| 367 | 5.51E−03 | 0 | 0 | 0 | 4.21E−04 |
| 368 | 5.65E−03 | 0 | 0 | 0 | 4.23E−04 |
| 369 | 5.80E−03 | 0 | 0 | 0 | 4.23E−04 |
| 370 | 5.96E−03 | 0 | 0 | 0 | 4.24E−04 |
| 371 | 6.11E−03 | 0 | 0 | 0 | 4.25E−04 |
| 372 | 6.27E−03 | 0 | 0 | 0 | 4.26E−04 |
| 373 | 6.43E−03 | 0 | 0 | 0 | 4.26E−04 |
| 374 | 6.58E−03 | 0 | 0 | 0 | 4.26E−04 |
| 375 | 6.74E−03 | 0 | 0 | 0 | 4.26E−04 |
| 376 | 6.91E−03 | 0 | 0 | 0 | 4.26E−04 |
| 377 | 7.07E−03 | 0 | 0 | 0 | 4.25E−04 |
| 378 | 7.23E−03 | 0 | 0 | 0 | 4.24E−04 |
| 379 | 7.39E−03 | 0 | 0 | 0 | 4.23E−04 |
| 380 | 7.55E−03 | 0 | 0 | 0 | 4.22E−04 |
| 381 | 7.71E−03 | 0 | 0 | 0 | 4.21E−04 |
| 382 | 7.87E−03 | 0 | 0 | 0 | 4.19E−04 |
| 383 | 8.03E−03 | 0 | 0 | 0 | 4.17E−04 |
| 384 | 8.19E−03 | 0 | 0 | 0 | 4.16E−04 |
| 385 | 8.35E−03 | 0 | 0 | 0 | 4.14E−04 |
| 386 | 8.50E−03 | 0 | 0 | 0 | 4.12E−04 |
| 387 | 8.66E−03 | 0 | 0 | 0 | 4.09E−04 |
| 388 | 8.81E−03 | 0 | 0 | 0 | 4.07E−04 |
| 389 | 8.95E−03 | 0 | 0 | 0 | 4.04E−04 |
| 390 | 9.10E−03 | 0 | 0 | 0 | 4.02E−04 |
| 391 | 9.24E−03 | 0 | 0 | 0 | 3.99E−04 |
| 392 | 9.38E−03 | 0 | 0 | 0 | 4.02E−04 |
| 393 | 9.52E−03 | 0 | 0 | 0 | 4.09E−04 |
| 394 | 9.65E−03 | 0 | 0 | 0 | 4.16E−04 |
| 395 | 9.78E−03 | 0 | 0 | 0 | 4.23E−04 |
| 396 | 9.91E−03 | 0 | 0 | 0 | 4.29E−04 |
| 397 | 1.00E−02 | 0 | 0 | 0 | 4.35E−04 |
| 398 | 1.01E−02 | 0 | 0 | 0 | 4.41E−04 |
| 399 | 1.03E−02 | 0 | 0 | 0 | 4.46E−04 |
| 400 | 1.04E−02 | 0 | 0 | 0 | 4.51E−04 |
| 401 | 1.05E−02 | 0 | 0 | 0 | 4.56E−04 |
| 402 | 1.06E−02 | 0 | 0 | 0 | 4.61E−04 |
| 403 | 1.07E−02 | 0 | 0 | 0 | 4.65E−04 |
| 404 | 1.07E−02 | 0 | 0 | 0 | 4.69E−04 |
| 405 | 1.08E−02 | 0 | 0 | 0 | 4.73E−04 |
| 406 | 1.09E−02 | 0 | 0 | 0 | 4.76E−04 |
| 407 | 1.10E−02 | 0 | 0 | 0 | 4.79E−04 |
| 408 | 1.10E−02 | 0 | 0 | 0 | 4.97E−04 |
| 409 | 1.11E−02 | 0 | 0 | 0 | 5.17E−04 |
| 410 | 1.11E−02 | 0 | 0 | 0 | 5.36E−04 |
| 411 | 1.12E−02 | 0 | 0 | 0 | 5.55E−04 |
| 412 | 1.12E−02 | 0 | 0 | 0 | 5.73E−04 |
| 413 | 1.12E−02 | 0 | 0 | 0 | 5.91E−04 |
| 414 | 1.13E−02 | 0 | 0 | 0 | 6.09E−04 |
| 415 | 1.13E−02 | 0 | 0 | 0 | 6.27E−04 |
| 416 | 1.13E−02 | 0 | 0 | 0 | 6.44E−04 |
| 417 | 1.13E−02 | 0 | 0 | 0 | 6.62E−04 |
| 418 | 1.12E−02 | 0 | 0 | 0 | 6.79E−04 |
| 419 | 1.12E−02 | 0 | 0 | 0 | 6.96E−04 |
| 420 | 1.12E−02 | 0 | 0 | 0 | 7.14E−04 |
| 421 | 1.11E−02 | 0 | 0 | 0 | 7.31E−04 |
| 422 | 1.11E−02 | 0 | 0 | 0 | 7.48E−04 |
| 423 | 1.10E−02 | 0 | 0 | 0 | 7.66E−04 |
| 424 | 1.10E−02 | 0 | 0 | 0 | 7.83E−04 |
| 425 | 1.09E−02 | 0 | 0 | 0 | 8.01E−04 |
| 426 | 1.08E−02 | 0 | 0 | 0 | 8.18E−04 |
| 427 | 1.07E−02 | 0 | 0 | 0 | 8.36E−04 |
| 428 | 1.06E−02 | 1E−08 | 0 | 0 | 8.54E−04 |
| 429 | 1.05E−02 | 2E−08 | 0 | 0 | 8.72E−04 |
| 430 | 1.04E−02 | 7E−08 | 0 | 0 | 8.91E−04 |
| 431 | 1.02E−02 | 0.0000002 | 0 | 0 | 9.10E−04 |
| 432 | 1.01E−02 | 5.5E−07 | 0 | 0 | 9.29E−04 |
| 433 | 9.94E−03 | 1.37E−06 | 0 | 0 | 9.49E−04 |
| 434 | 9.78E−03 | 3.17E−06 | 0 | 0 | 9.67E−04 |
| 435 | 9.61E−03 | 6.84E−06 | 0 | 0 | 9.86E−04 |
| 436 | 9.43E−03 | 1.386E−05 | 0 | 0 | 1.00E−03 |
| 437 | 9.25E−03 | 2.644E−05 | 0 | 0 | 1.02E−03 |
| 438 | 9.06E−03 | 0.0000478 | 0 | 0 | 1.04E−03 |
| 439 | 8.86E−03 | 8.223E−05 | 0 | 0 | 1.06E−03 |
| 440 | 8.65E−03 | 0.0001352 | 0 | 0 | 1.07E−03 |
| 441 | 8.44E−03 | 0.0002131 | 0 | 0 | 1.09E−03 |
| 442 | 8.22E−03 | 0.0003233 | 0 | 0 | 1.10E−03 |
| 443 | 7.99E−03 | 0.0004737 | 0 | 0 | 1.12E−03 |
| 444 | 7.76E−03 | 0.000672 | 0 | 0 | 1.14E−03 |
| 445 | 7.52E−03 | 0.0009257 | 0 | 0 | 1.15E−03 |
| 446 | 7.28E−03 | 0.0012411 | 0 | 0 | 1.17E−03 |
| 447 | 7.04E−03 | 0.0016232 | 0 | 0 | 1.19E−03 |
| 448 | 6.79E−03 | 0.0020751 | 0 | 0 | 1.21E−03 |
| 449 | 6.54E−03 | 0.0025979 | 0 | 0 | 1.22E−03 |
| 450 | 6.29E−03 | 0.0031907 | 0 | 0 | 1.24E−03 |
| 451 | 6.04E−03 | 0.0038503 | 0 | 0 | 1.26E−03 |
| 452 | 5.78E−03 | 0.0045716 | 0 | 0 | 1.29E−03 |
| 453 | 5.53E−03 | 0.0053479 | 0 | 0 | 1.31E−03 |
| 454 | 5.28E−03 | 0.006171 | 0 | 0 | 1.33E−03 |
| 455 | 5.03E−03 | 0.0070318 | 0 | 0 | 1.36E−03 |
| 456 | 4.78E−03 | 0.0079203 | 0 | 0 | 1.38E−03 |
| 457 | 4.54E−03 | 0.0088266 | 0 | 0 | 1.41E−03 |
| 458 | 4.30E−03 | 0.0097403 | 0 | 0 | 1.44E−03 |
| 459 | 4.06E−03 | 0.0106519 | 0 | 0 | 1.47E−03 |
| 460 | 3.83E−03 | 0.0115518 | 0 | 0 | 1.50E−03 |
| 461 | 3.60E−03 | 0.0124314 | 0 | 0 | 1.54E−03 |
| 462 | 3.38E−03 | 0.0132831 | 0 | 0 | 1.57E−03 |
| 463 | 3.17E−03 | 0.0140998 | 0 | 0 | 1.61E−03 |
| 464 | 2.97E−03 | 0.0148757 | 0 | 0 | 1.64E−03 |
| 465 | 2.77E−03 | 0.0156057 | 0 | 0 | 1.68E−03 |
| 466 | 2.58E−03 | 0.0162858 | 0 | 0 | 1.72E−03 |
| 467 | 2.39E−03 | 0.0169127 | 0 | 0 | 1.76E−03 |
| 468 | 2.22E−03 | 0.0174841 | 0 | 0 | 1.80E−03 |
| 469 | 2.06E−03 | 0.0179985 | 0 | 0 | 1.85E−03 |
| 470 | 1.90E−03 | 0.0184549 | 0 | 0 | 1.89E−03 |
| 471 | 1.75E−03 | 0.018853 | 0 | 0 | 1.94E−03 |
| 472 | 1.61E−03 | 0.0191932 | 0 | 0 | 1.98E−03 |
| 473 | 1.48E−03 | 0.019476 | 0 | 0 | 2.03E−03 |
| 474 | 1.36E−03 | 0.0197027 | 0 | 0 | 2.08E−03 |
| 475 | 1.24E−03 | 0.0198746 | 0 | 0 | 2.13E−03 |
| 476 | 1.14E−03 | 0.0199935 | 0 | 0 | 2.18E−03 |
| 477 | 1.04E−03 | 0.0200613 | 0 | 0 | 2.24E−03 |
| 478 | 9.44E−04 | 0.0200801 | 0 | 0 | 2.29E−03 |
| 479 | 8.59E−04 | 0.0200522 | 0 | 0 | 2.35E−03 |
| 480 | 7.81E−04 | 0.01998 | 0 | 0 | 2.40E−03 |
| 481 | 7.09E−04 | 0.0198658 | 0 | 0 | 2.46E−03 |
| 482 | 6.43E−04 | 0.0197121 | 0 | 0 | 2.52E−03 |
| 483 | 5.82E−04 | 0.0195214 | 0 | 0 | 2.58E−03 |
| 484 | 5.27E−04 | 0.0192962 | 0 | 0 | 2.64E−03 |
| 485 | 4.77E−04 | 0.0190389 | 0 | 0 | 2.70E−03 |
| 486 | 4.31E−04 | 0.018752 | 0 | 0 | 2.77E−03 |
| 487 | 3.89E−04 | 0.0184378 | 0 | 0 | 2.83E−03 |
| 488 | 3.51E−04 | 0.0180987 | 0 | 0 | 2.90E−03 |
| 489 | 3.16E−04 | 0.0177369 | 1E−08 | 0 | 2.97E−03 |
| 490 | 2.85E−04 | 0.0173548 | 3E−08 | 0 | 3.04E−03 |
| 491 | 2.56E−04 | 0.0169544 | 9E−08 | 0 | 3.11E−03 |
| 492 | 2.31E−04 | 0.0165378 | 2.3E−07 | 0 | 3.18E−03 |
| 493 | 2.08E−04 | 0.0161072 | 5.6E−07 | 0 | 3.25E−03 |
| 494 | 1.87E−04 | 0.0156643 | 1.24E−06 | 0 | 3.32E−03 |
| 495 | 1.68E−04 | 0.015211 | 0.0000026 | 0 | 3.40E−03 |
| 496 | 1.51E−04 | 0.0147493 | 5.19E−06 | 0 | 3.47E−03 |
| 497 | 1.36E−04 | 0.0142807 | 9.84E−06 | 0 | 3.55E−03 |
| 498 | 1.22E−04 | 0.013807 | 1.781E−05 | 0 | 3.62E−03 |
| 499 | 1.10E−04 | 0.0133296 | 3.088E−05 | 0 | 3.70E−03 |
| 500 | 9.85E−05 | 0.0128502 | 5.146E−05 | 0 | 3.77E−03 |
| 501 | 8.85E−05 | 0.0123702 | 8.263E−05 | 0 | 3.85E−03 |
| 502 | 7.95E−05 | 0.0118908 | 0.0001282 | 0 | 3.93E−03 |
| 503 | 7.14E−05 | 0.0114135 | 0.0001926 | 0 | 4.01E−03 |
| 504 | 6.42E−05 | 0.0109393 | 0.0002809 | 0 | 4.08E−03 |
| 505 | 5.77E−05 | 0.0104696 | 0.0003985 | 0 | 4.16E−03 |
| 506 | 5.18E−05 | 0.0100054 | 0.0005511 | 0 | 4.24E−03 |
| 507 | 4.66E−05 | 0.0095477 | 0.0007442 | 0 | 4.32E−03 |
| 508 | 4.19E−05 | 0.0090975 | 0.0009829 | 0 | 4.39E−03 |
| 509 | 3.76E−05 | 0.0086556 | 0.0012718 | 0 | 4.47E−03 |
| 510 | 3.38E−05 | 0.008223 | 0.0016143 | 0 | 4.55E−03 |
| 511 | 3.04E−05 | 0.0078003 | 0.0020131 | 0 | 4.63E−03 |
| 512 | 2.74E−05 | 0.0073883 | 0.0024691 | 0 | 4.70E−03 |
| 513 | 2.46E−05 | 0.0069875 | 0.0029822 | 0 | 4.78E−03 |
| 514 | 2.22E−05 | 0.0065986 | 0.0035508 | 0 | 4.86E−03 |
| 515 | 1.99E−05 | 0.0062221 | 0.0041719 | 0 | 4.93E−03 |
| 516 | 1.80E−05 | 0.0058582 | 0.0048411 | 0 | 5.01E−03 |
| 517 | 1.62E−05 | 0.0055075 | 0.0055532 | 0 | 5.08E−03 |
| 518 | 1.46E−05 | 0.0051701 | 0.0063019 | 0 | 5.15E−03 |
| 519 | 1.31E−05 | 0.0048462 | 0.0070802 | 0 | 5.22E−03 |
| 520 | 1.18E−05 | 0.0045361 | 0.0078805 | 0 | 5.30E−03 |
| 521 | 1.07E−05 | 0.0042397 | 0.0086952 | 0 | 5.37E−03 |
| 522 | 9.61E−06 | 0.0039571 | 0.0095163 | 0 | 5.44E−03 |
| 523 | 8.67E−06 | 0.0036882 | 0.0103361 | 0 | 5.51E−03 |
| 524 | 7.82E−06 | 0.0034329 | 0.0111471 | 0 | 5.58E−03 |
| 525 | 7.06E−06 | 0.003191 | 0.0119422 | 0 | 5.64E−03 |
| 526 | 6.37E−06 | 0.0029623 | 0.0127149 | 0 | 5.71E−03 |
| 527 | 5.76E−06 | 0.0027465 | 0.0134591 | 0 | 5.77E−03 |
| 528 | 5.20E−06 | 0.0025433 | 0.0141696 | 0 | 5.84E−03 |
| 529 | 4.70E−06 | 0.0023523 | 0.0148416 | 0 | 5.90E−03 |
| 530 | 4.25E−06 | 0.0021732 | 0.0154714 | 0 | 5.97E−03 |
| 531 | 3.84E−06 | 0.0020055 | 0.0160555 | 0 | 6.03E−03 |
| 532 | 3.48E−06 | 0.0018487 | 0.0165915 | 0 | 6.09E−03 |
| 533 | 3.14E−06 | 0.0017025 | 0.0170775 | 0 | 6.15E−03 |
| 534 | 2.85E−06 | 0.0015663 | 0.017512 | 0 | 6.21E−03 |
| 535 | 2.58E−06 | 0.0014396 | 0.0178945 | 0 | 6.27E−03 |
| 536 | 2.33E−06 | 0.001322 | 0.0182246 | 0 | 6.32E−03 |
| 537 | 2.11E−06 | 0.0012131 | 0.0185026 | 0 | 6.38E−03 |
| 538 | 1.92E−06 | 0.0011122 | 0.0187292 | 0 | 6.43E−03 |
| 539 | 1.74E−06 | 0.0010189 | 0.0189053 | 0 | 6.48E−03 |
| 540 | 1.58E−06 | 0.0009329 | 0.0190322 | 0 | 6.53E−03 |
| 541 | 1.43E−06 | 0.0008535 | 0.0191116 | 1E−08 | 6.58E−03 |
| 542 | 1.30E−06 | 0.0007804 | 0.0191452 | 2E−08 | 6.63E−03 |
| 543 | 1.18E−06 | 0.0007132 | 0.0191349 | 4E−08 | 6.67E−03 |
| 544 | 1.07E−06 | 0.0006514 | 0.019083 | 8E−08 | 6.72E−03 |
| 545 | 9.70E−07 | 0.0005947 | 0.0189916 | 1.7E−07 | 6.76E−03 |
| 546 | 8.80E−07 | 0.0005427 | 0.018863 | 3.3E−07 | 6.80E−03 |
| 547 | 8.00E−07 | 0.0004951 | 0.0186996 | 6.3E−07 | 6.84E−03 |
| 548 | 7.30E−07 | 0.0004515 | 0.0185036 | 1.17E−06 | 6.88E−03 |
| 549 | 6.60E−07 | 0.0004115 | 0.0182775 | 2.09E−06 | 6.92E−03 |
| 550 | 6.00E−07 | 0.000375 | 0.0180236 | 0.0000036 | 6.95E−03 |
| 551 | 5.50E−07 | 0.0003417 | 0.0177442 | 6.03E−06 | 6.99E−03 |
| 552 | 5.00E−07 | 0.0003112 | 0.0174416 | 9.81E−06 | 7.02E−03 |
| 553 | 4.60E−07 | 0.0002835 | 0.017118 | 1.552E−05 | 7.05E−03 |
| 554 | 4.20E−07 | 0.0002581 | 0.0167755 | 2.394E−05 | 7.08E−03 |
| 555 | 3.80E−Q7 | 0.000235 | 0.0164161 | 3.601E−05 | 7.10E−03 |
| 556 | 3.50E−07 | 0.0002139 | 0.016042 | 5.295E−05 | 7.12E−03 |
| 557 | 3.20E−07 | 0.0001947 | 0.015655 | 7.617E−05 | 7.15E−03 |
| 558 | 2.90E−07 | 0.0001772 | 0.0152569 | 0.0001073 | 7.17E−03 |
| 559 | 2.60E−07 | 0.0001613 | 0.0148494 | 0.0001483 | 7.18E−03 |
| 560 | 2.40E−07 | 0.0001468 | 0.0144344 | 0.0002013 | 7.20E−03 |
| 561 | 2.20E−07 | 0.0001336 | 0.0140132 | 0.0002684 | 7.21E−03 |
| 562 | 2.00E−07 | 0.0001216 | 0.0135874 | 0.000352 | 7.22E−03 |
| 563 | 1.80E−07 | 0.0001107 | 0.0131585 | 0.0004547 | 7.23E−03 |
| 564 | 1.70E−07 | 0.0001008 | 0.0127277 | 0.0005787 | 7.23E−03 |
| 565 | 1.50E−07 | 9.174E−05 | 0.0122962 | 0.0007263 | 7.24E−03 |
| 566 | 1.40E−07 | 8.352E−05 | 0.0118653 | 0.0008998 | 7.24E−03 |
| 567 | 1.30E−07 | 7.605E−05 | 0.0114361 | 0.001101 | 7.24E−03 |
| 568 | 1.20E−07 | 6.925E−05 | 0.0110094 | 0.0013315 | 7.23E−03 |
| 569 | 1.10E−07 | 6.307E−05 | 0.0105864 | 0.0015926 | 7.22E−03 |
| 570 | 1.00E−07 | 5.745E−05 | 0.0101679 | 0.0018849 | 7.21E−03 |
| 571 | 9.00E−08 | 5.233E−05 | 0.0097547 | 0.002209 | 7.20E−03 |
| 572 | 8.00E−08 | 4.768E−05 | 0.0093475 | 0.0025645 | 7.18E−03 |
| 573 | 8.00E−08 | 4.345E−05 | 0.0089471 | 0.002951 | 7.16E−03 |
| 574 | 7.00E−08 | 0.0000396 | 0.0085541 | 0.0033674 | 7.14E−03 |
| 575 | 6.00E−08 | 0.0000361 | 0.0081689 | 0.003812 | 7.12E−03 |
| 576 | 6.00E−08 | 3.292E−05 | 0.0077923 | 0.004283 | 7.10E−03 |
| 577 | 5.00E−08 | 3.002E−05 | 0.0074246 | 0.0047779 | 7.07E−03 |
| 578 | 5.00E−08 | 2.738E−05 | 0.0070663 | 0.0052941 | 7.04E−03 |
| 579 | 4.00E−08 | 2.498E−05 | 0.0067176 | 0.0058286 | 7.01E−03 |
| 580 | 4.00E−08 | 2.279E−05 | 0.006379 | 0.0063782 | 6.98E−03 |
| 581 | 4.00E−08 | 0.0000208 | 0.0060507 | 0.0069395 | 6.94E−03 |
| 582 | 3.00E−08 | 1.899E−05 | 0.0057328 | 0.0075091 | 6.91E−03 |
| 583 | 3.00E−08 | 1.734E−05 | 0.0054257 | 0.0080832 | 6.87E−03 |
| 584 | 3.00E−08 | 1.584E−05 | 0.0051294 | 0.0086586 | 6.83E−03 |
| 585 | 3.00E−08 | 1.447E−05 | 0.0048439 | 0.0092315 | 6.78E−03 |
| 586 | 2.00E−08 | 1.322E−05 | 0.0045695 | 0.0097986 | 6.74E−03 |
| 587 | 2.00E−08 | 1.209E−05 | 0.0043059 | 0.0103567 | 6.69E−03 |
| 588 | 2.00E−08 | 1.105E−05 | 0.0040533 | 0.0109026 | 6.64E−03 |
| 589 | 2.00E−08 | 0.0000101 | 0.0038116 | 0.0114334 | 6.58E−03 |
| 590 | 2.00E−08 | 9.24E−06 | 0.0035806 | 0.0119465 | 6.52E−03 |
| 591 | 2.00E−08 | 8.45E−06 | 0.0033602 | 0.0124392 | 6.46E−03 |
| 592 | 2.00E−08 | 7.74E−06 | 0.0031503 | 0.0129094 | 6.40E−03 |
| 593 | 1.00E−08 | 7.08E−06 | 0.0029506 | 0.0133552 | 6.33E−03 |
| 594 | 1.00E−08 | 6.48E−06 | 0.002761 | 0.0137748 | 6.26E−03 |
| 595 | 1.00E−08 | 5.94E−06 | 0.0025811 | 0.0141667 | 6.19E−03 |
| 596 | 1.00E−08 | 5.44E−06 | 0.0024109 | 0.0145298 | 6.12E−03 |
| 597 | 1.00E−08 | 4.98E−06 | 0.0022498 | 0.014863 | 6.04E−03 |
| 598 | 1.00E−08 | 4.57E−06 | 0.0020978 | 0.0151657 | 5.96E−03 |
| 599 | 1.00E−08 | 4.19E−06 | 0.0019544 | 0.0154373 | 5.88E−03 |
| 600 | 1.00E−08 | 3.84E−06 | 0.0018194 | 0.0156775 | 5.80E−03 |
| 601 | 1.00E−08 | 3.52E−06 | 0.0016925 | 0.0158863 | 5.71E−03 |
| 602 | 1.00E−08 | 3.23E−06 | 0.0015732 | 0.0160638 | 5.63E−03 |
| 603 | 1.00E−08 | 2.97E−06 | 0.0014613 | 0.0162101 | 5.54E−03 |
| 604 | 1.00E−08 | 2.72E−06 | 0.0013565 | 0.0163258 | 5.45E−03 |
| 605 | 1.00E−08 | 0.0000025 | 0.0012583 | 0.0164113 | 5.36E−03 |
| 606 | 0.00E−00 | 0.0000023 | 0.0011666 | 0.0164673 | 5.26E−03 |
| 607 | 0.00E+00 | 2.11E−06 | 0.0010809 | 0.0164948 | 5.17E−03 |
| 608 | 0.00E+00 | 1.94E−06 | 0.0010009 | 0.0164944 | 5.07E−03 |
| 609 | 0.00E−00 | 1.78E−06 | 0.0009264 | 0.0164672 | 4.98E−03 |
| 610 | 0.00E−00 | 1.64E−06 | 0.000857 | 0.0164143 | 4.88E−03 |
| 611 | 0.00E+00 | 1.51E−06 | 0.0007924 | 0.0163367 | 4.78E−03 |
| 612 | 0.00E+00 | 1.38E−06 | 0.0007324 | 0.0162355 | 4.68E−03 |
| 613 | 0.00E−00 | 1.27E−06 | 0.0006766 | 0.0161121 | 4.58E−03 |
| 614 | 0.00E−00 | 1.17E−06 | 0.0006249 | 0.0159675 | 4.48E−03 |
| 615 | 0.00E+00 | 1.08E−06 | 0.0005769 | 0.015803 | 4.38E−03 |
| 616 | 0.00E+00 | 9.9E−07 | 0.0005324 | 0.0156198 | 4.28E−03 |
| 617 | 0.00E+00 | 9.2E−07 | 0.0004912 | 0.0154192 | 4.18E−03 |
| 618 | 0.00E−00 | 8.4E−07 | 0.0004531 | 0.0152023 | 4.08E−03 |
| 619 | 0.00E+00 | 7.8E−07 | 0.0004178 | 0.0149705 | 3.98E−03 |
| 620 | 0.00E+00 | 7.2E−07 | 0.0003852 | 0.0147249 | 3.88E−03 |
| 621 | 0.00E−00 | 6.6E−07 | 0.000355 | 0.0144667 | 3.78E−03 |
| 622 | 0.00E−00 | 6.1E−07 | 0.0003272 | 0.0141971 | 3.68E−03 |
| 623 | 0.00E−00 | 5.6E−07 | 0.0003015 | 0.0139171 | 3.58E−03 |
| 624 | 0.00E−00 | 5.2E−07 | 0.0002777 | 0.013628 | 3.48E−03 |
| 625 | 0.00E+00 | 4.8E−07 | 0.0002558 | 0.0133307 | 3.38E−03 |
| 626 | 0.00E+00 | 4.4E−07 | 0.0002356 | 0.0130263 | 3.28E−03 |
| 627 | 0.00E+00 | 4.1E−07 | 0.000217 | 0.0127158 | 3.18E−03 |
| 628 | 0.00E+00 | 3.8E−07 | 0.0001998 | 0.0124001 | 3.08E−03 |
| 629 | 0.00E+00 | 3.5E−07 | 0.000184 | 0.0120802 | 2.99E−03 |
| 630 | 0.00E+00 | 3.2E−07 | 0.0001695 | 0.0117569 | 2.89E−03 |
| 631 | 0.00E−00 | 0.0000003 | 0.000156 | 0.0114312 | 2.80E−03 |
| 632 | 0.00E+00 | 2.7E−07 | 0.0001437 | 0.0111037 | 2.71E−03 |
| 633 | 0.00E−00 | 2.5E−07 | 0.0001323 | 0.0107753 | 2.62E−03 |
| 634 | 0.00E+00 | 2.3E−07 | 0.0001218 | 0.0104467 | 2.53E−03 |
| 635 | 0.00E+00 | 2.2E−07 | 0.0001122 | 0.0101185 | 2.44E−03 |
| 636 | 0.00E+00 | 0.0000002 | 0.0001033 | 0.0097915 | 2.35E−03 |
| 637 | 0.00E+00 | 1.9E−07 | 9.512E−05 | 0.0094662 | 2.27E−03 |
| 638 | 0.00E−00 | 1.7E−07 | 0.0000876 | 0.0091432 | 2.18E−03 |
| 639 | 0.00E−00 | 1.6E−07 | 8.068E−05 | 0.0088231 | 2.10E−03 |
| 640 | 0.00E−00 | 1.5E−07 | 7.431E−05 | 0.0085063 | 2.02E−03 |
| 641 | 0.00E−00 | 1.4E−07 | 6.845E−05 | 0.0081934 | 1.94E−03 |
| 642 | 0.00E−00 | 1.3E−07 | 6.306E−05 | 0.0078848 | 1.86E−03 |
| 643 | 0.00E−00 | 1.2E−07 | 0.0000581 | 0.0075808 | 1.79E−03 |
| 644 | 0.00E+00 | 1.1E−07 | 5.354E−05 | 0.0072819 | 1.71E−03 |
| 645 | 0.00E+00 | 0.0000001 | 4.934E−05 | 0.0069885 | 1.64E−03 |
| 646 | 0.00E+00 | 9E−08 | 4.547E−05 | 0.0067008 | 1.57E−03 |
| 647 | 0.00E−00 | 9E−08 | 4.192E−05 | 0.0064191 | 1.50E−03 |
| 648 | 0.00E+00 | 8E−08 | 3.864E−05 | 0.0061438 | 1.43E−03 |
| 649 | 0.00E+00 | 7E−08 | 3.563E−05 | 0.0058749 | 1.37E−03 |
| 650 | 0.00E−00 | 7E−08 | 3.286E−05 | 0.0056128 | 1.31E−03 |
| 651 | 0.00E−00 | 6E−08 | 3.031E−05 | 0.0053575 | 1.24E−03 |
| 652 | 0.00E+00 | 6E−08 | 2.796E−05 | 0.0051094 | 1.19E−03 |
| 653 | 0.00E+00 | 6E−08 | 2.579E−05 | 0.0048684 | 1.13E−03 |
| 654 | 0.00E+00 | 5E−08 | 0.0000238 | 0.0046347 | 1.07E−03 |
| 655 | 0.00E+00 | 5E−08 | 2.196E−05 | 0.0044084 | 1.02E−03 |
| 656 | 0.00E+00 | 4E−08 | 2.027E−05 | 0.0041895 | 9.68E−04 |
| 657 | 0.00E+00 | 4E−08 | 1.872E−05 | 0.0039781 | 9.19E−04 |
| 658 | 0.00E+00 | 4E−08 | 1.728E−05 | 0.0037741 | 8.71E−04 |
| 659 | 0.00E+00 | 4E−08 | 1.596E−05 | 0.0035776 | 8.25E−04 |
| 660 | 0.00E+00 | 3E−08 | 1.474E−05 | 0.0033885 | 7.81E−04 |
| 661 | 0.00E+00 | 3E−08 | 1.362E−05 | 0.0032067 | 7.38E−04 |
| 662 | 0.00E+00 | 3E−08 | 1.259E−05 | 0.0030323 | 6.97E−04 |
| 663 | 0.00E+00 | 3E−08 | 1.163E−05 | 0.0028651 | 6.59E−04 |
| 664 | 0.00E+00 | 3E−08 | 1.075E−05 | 0.002705 | 6.21E−04 |
| 665 | 0.00E+00 | 2E−08 | 9.94E−06 | 0.0025519 | 5.86E−04 |
| 666 | 0.00E+00 | 2E−08 | 9.19E−06 | 0.0024056 | 5.52E−04 |
| 667 | 0.00E+00 | 2E−08 | 0.0000085 | 0.0022661 | 5.20E−04 |
| 668 | 0.00E+00 | 2E−08 | 7.87E−06 | 0.0021331 | 4.89E−04 |
| 669 | 0.00E+00 | 2E−08 | 7.28E−06 | 0.0020066 | 4.60E−04 |
| 670 | 0.00E+00 | 2E−08 | 6.74E−06 | 0.0018862 | 4.32E−04 |
| 671 | 0.00E+00 | 2E−08 | 6.23E−06 | 0.0017719 | 4.06E−04 |
| 672 | 0.00E+00 | 1E−08 | 5.77E−06 | 0.0016635 | 3.81E−04 |
| 673 | 0.00E+00 | 1E−08 | 5.34E−06 | 0.0015607 | 3.58E−04 |
| 674 | 0.00E+00 | 1E−08 | 4.95E−06 | 0.0014634 | 3.35E−04 |
| 675 | 0.00E+00 | 1E−08 | 4.59E−06 | 0.0013714 | 3.14E−04 |
| 676 | 0.00E+00 | 1E−08 | 4.25E−06 | 0.0012844 | 2.94E−04 |
| 677 | 0.00E+00 | 1E−08 | 3.94E−06 | 0.0012024 | 2.75E−04 |
| 678 | 0.00E+00 | 1E−08 | 3.65E−06 | 0.0011249 | 2.58E−04 |
| 679 | 0.00E+00 | 1E−08 | 3.38E−06 | 0.001052 | 2.41E−04 |
| 680 | 0.00E+00 | 1E−08 | 3.14E−06 | 0.0009833 | 2.25E−04 |
| 681 | 0.00E+00 | 1E−08 | 2.91E−06 | 0.0009186 | 2.10E−04 |
| 682 | 0.00E+00 | 1E−08 | 0.0000027 | 0.0008579 | 1.96E−04 |
| 683 | 0.00E+00 | 1E−08 | 2.51E−06 | 0.0008008 | 1.83E−04 |
| 684 | 0.00E+00 | 1E−08 | 2.32E−06 | 0.0007473 | 1.71E−04 |
| 685 | 0.00E+00 | 1E−08 | 2.16E−06 | 0.000697 | 1.60E−04 |
| 686 | 0.00E+00 | 1E−08 | 0.000002 | 0.0006499 | 1.49E−04 |
| 687 | 0.00E+00 | 1E−08 | 1.86E−06 | 0.0006058 | 1.39E−04 |
| 688 | 0.00E+00 | 0 | 1.73E−06 | 0.0005646 | 1.29E−04 |
| 689 | 0.00E+00 | 0 | 1.61E−06 | 0.0005259 | 1.20E−04 |
| 690 | 0.00E+00 | 0 | 1.49E−06 | 0.0004898 | 1.12E−04 |
| 691 | 0.00E+00 | 0 | 1.39E−06 | 0.0004561 | 1.04E−04 |
| 692 | 0.00E+00 | 0 | 1.29E−06 | 0.0004246 | 9.73E−05 |
| 693 | 0.00E+00 | 0 | 0.0000012 | 0.0003951 | 9.05E−05 |
| 694 | 0.00E+00 | 0 | 1.11E−06 | 0.0003677 | 8.43E−05 |
| 695 | 0.00E+00 | 0 | 1.04E−06 | 0.0003421 | 7.84E−05 |
| 696 | 0.00E+00 | 0 | 9.6E−07 | 0.0003182 | 7.29E−05 |
| 697 | 0.00E+00 | 0 | 0.0000009 | 0.0002959 | 6.78E−05 |
| 698 | 0.00E+00 | 0 | 8.4E−07 | 0.0002752 | 6.31E−05 |
| 699 | 0.00E+00 | 0 | 7.8E−07 | 0.0002559 | 5.86E−05 |
| 700 | 0.00E+00 | 0 | 7.2E−07 | 0.0002379 | 5.45E−05 |

Although particular embodiments of the present invention have been illustrated and described, it is obvious that various other changes and modifications may be made within the spirit and scope of the invention. The present text is therefore intended to cover in the appended claims all modifications that fall within the scope of the present invention.

1. A multi-glazing adapted to be mounted in a building, on a facade and/or on the roof, comprising at least an exterior laminated glazing and an interior glazing separated by a gas gap and respectively intended to be arranged towards an outside and an inside of the building, said laminated glazing integrating a transparent layered element comprising two smooth outer main surfaces, as well as:
two outer layers, comprising a lower outer layer and an upper outer layer, at least one of which is a laminating interlayer, and which each form one of two main outer surfaces of the layered element and which are made of dielectric materials having substantially the same refractive index; and
a central layer interposed between the outer layers, said central layer being formed either by a single layer, which is a dielectric layer with a refractive index different from that of the outer layers, or a metallic layer, or by a stack of layers, which comprises at least one dielectric layer with a refractive index different to that of the outer layers or a metallic layer, wherein a first portion of each contact surface between two adjacent layers of the layered element, one of which is dielectric and the other one of which is metallic, or which are two dielectric layers with a different refractive index, is textured and parallel to the other textured contact surfaces between two adjacent layers, and wherein a second portion of each contact surface between two adjacent layers of the layered element is smooth, wherein said first portion forms a textured pattern, which contrasts with a background formed by the second portion, said pattern being such that:
each subset of said pattern is separated from an adjacent subset by a distance of less than 10.16 cm,
said pattern has, relative to the background, a visibility “SCORE” greater than or equal to 0, and which satisfies the equation:
$$SCORE = 0.85 * Δ S + 0.15 * Δ L$$
Where AS is the chromatic contrast and satisfies the equation:
$$SCORE = 0.85 * Δ S + 0.15 * Δ L$$
Where “wi” is the Weber fraction representing the sensitivity of a cone “i” of the retina of a bird,
Where “Δfi” is the real perception difference between said pattern and the background,
Where “fi” satisfies the equation:
$$fi = In ( Qi / Qi\_ref )$$
where Qi is the sensory response of a cone “i” of the retina of a bird and satisfies the equation:
$${Q}_{i} = {\int }_{λ} {R}_{i} ( λ ) S ( λ ) I ( λ ) d λ$$
Where “λ” is the wavelength, “S” is the considered spectrum, “I” is the illuminant D65 according to standard EN410 which describes the average solar spectrum and “Ri” is the sensitivity spectrum of said cone “i”,
Where “Qi_ref” corresponds to “Qi” with S equal to 1,
Where “ΔL” is the achromatic contrast and satisfies the equation:
$$AL = Δ f\_achromatic / w\_achromatic$$
Where “w_achromatic” is equal to 0.1 is the Weber fraction representing the achromatic sensitivity of the retina of a bird,
Where “Δf_achromatic” is the difference in real achromatic perception between said pattern and the background,
Where “f_achromatic” satisfies the equation:
$$f\_achromatic = In ( Q / Q\_ref )$$
Where Q is the achromatic sensory response of the retina of a bird and satisfies the equation:
$$Q = {\int }_{λ} R ( λ ) S ( λ ) I ( λ ) d λ$$
Where “R” is the achromatic sensitivity spectrum,
Where “Q_ref” corresponds to “Q” with S equal to 1.

2. The multi-glazing according to claim 1, wherein said laminated glazing integrates an electrochromic stack.

3. The multi-glazing according to claim 2, wherein said electrochromic stack is in contact with said gas gap.

4. The multi-glazing according to claim 2, wherein said electrochromic stack at least partly forms said central layer.

5. The multi-glazing according to claim 1, characterized in that wherein one of said outer layers of the layered element is formed by an exterior substrate of said laminated glazing intended to be arranged towards the outside of the building.

6. The multi-glazing according to claim 1, wherein one of said outer layers of the layered element is formed by an interior substrate of said laminated glazing intended to be arranged towards the inside of the building.

7. The multi-glazing according to claim 1, wherein the Weber “wi” fraction representing the sensitivity of a cone “i” of the retina of a bird is selected according to the following specific values: W1=0.2; W2=0.14142; W3=0.14142; W4=0.1.

8. The multi-glazing according to claim 1, wherein said pattern comprises wavy or rectilinear strips.

9. The multi-glazing according to claim 1, wherein said pattern comprises dots.

10. A method comprising a step of manufacturing a multi-glazing according to claim 1.

11. A method comprising a step of mounting at least one multi-glazing according to claim 1 in a building, on a facade and/or on the roof.

12. The multi-glazing according to claim 1, wherein each subset of said pattern is separated from an adjacent subset by a distance of less than 5.08 cm.
